(19) United States
(12) Patent Application Publication
(10) Pub. No.: US 2020/0156715 A1
(43) Pub. Date: May 21, 2020

(54) Retractable Aerodynamic Deflector

(71) Applicant: Compagnie Plastic Omnium, Lyon (FR)

(72) Inventors: Gérald Andre, Saint Denis en Bugey (FR); Bertrand Mazue, Lyon (FR)

(21) Appl. No.: 16/472,739

(22) PCT Filed: Dec. 11, 2017
(86) PCT No.: PCT/FR2017/053485

§ 371 Date: Jun. 21, 2019

(30) Foreign Application Priority Data
Dec. 21, 2016 (FR) 1663000

(51) Int. Cl. B62D 35/00; B62D 35/02

(52) U.S. Cl. CPC B62D 35/005; B62D 35/02

(57) ABSTRACT

The invention relates to an aerodynamic deflector arranged at the front of a motor vehicle with a deformable skin of which an upper strip is rigidly connected to the lower portion of a front bumper, and of which a lower strip is connected to a front edge of a rigid arch that can be moved by a manoeuvring device between a low position in which the deformable skin is deployed so as to divert the flow of air that presents under the vehicle when the vehicle advances, and a high position in which the deformable skin is folded away in a recess arranged behind the bumper.

### FIELD OF THE INVENTION

The invention relates to the field of motor vehicles, and more particularly aerodynamic devices arranged at the front of a vehicle to reduce the aerodynamic drag generated by this vehicle travelling at high speed.

### BACKGROUND OF THE INVENTION

One of the means used for many years to improve the aerodynamic efficiency of vehicles consists in reducing the underbody space between the road and the vehicle.

Since the vehicle ground clearance must remain at a height compatible with the use requirements, a satisfactory result can be obtained by lowering an aerodynamic barrier acting as deflector at the front part of the vehicle, and preferably arranged in front of the wheels.

This deflector can therefore be lowered or raised depending on the driving conditions such as the vehicle speed or road condition.

Publication U.S. Pat. No. 7,775,582 provides an example of this type of device.

However, other constraints must also be taken into account to implement these deflectors. We may mention for example the size of the device in the raised position in a reduced space located at the front of the vehicle, the mechanical strength to oppose the air pressure when the vehicle is travelling at high speed, the protection of the device and the deformability of the device in case of head-on impact, the possibility of folding away the device very quickly when an unplanned obstacle appears on the road, and the ease of repair in case of damage.

Lastly, an additional constraint is due to the style requirements inherent to this part of the vehicle, in which the aerodynamic device is visible from the outside and is an integral part of the bodywork. The aerodynamic deflector therefore has curved shapes designed to preserve the continuity of shape and style with the lower part of the bumper.

Numerous publications have proposed to solve all or some of the above-mentioned constraints.

For example, publication U.S. Pat. No. 7,775,582 already mentioned proposes a rigid system actuated by cable, which is difficult to operate and relatively bulky. This device also represents an obstacle to the deformability of the front part in case of head-on impact.

Publication U.S. Pat. No. 8,677,817 describes an inflatable aerodynamic deflector of reduced size and total deformability. However, this device has low resistance to air pressure when the vehicle is travelling at high speed, and requires the installation of a compressed air source inside the vehicle.

The device described in publication U.S. Pat. No. 8,702,152 consists of a vertically movable aerodynamic deflector. It is difficult to protect this device against the hazards of the road and it cannot be disengaged easily. In addition, in case of head-on impact, its rigid structure located at the very front of the vehicle is easily damaged and obstructs the deformation of the front block towards the rear of the vehicle. Similar devices are proposed by publications U.S. Pat. No. 4,951,994 or U.S. Pat. No. 7,686,382.

Publication U.S. Pat. No. 7,686,383 proposes to deploy a plurality of curved flaps arranged in the extension of the lower part of the bumper. This device offers the advantage of following the curve of the bumper, but its highly complex implementation is relatively incompatible with the robustness and cost requirements imposed by car manufacturers.

Publication U.S. Pat. No. 8,887,845 provides for separating the aerodynamic barrier into three separate flaps pivoting on flexible and curved axes. This results in significant driving forces to compensate for the transmission losses.

The device described in publication U.S. Pat. No. 4,659,130 remains bulky and is difficult to fold away quickly if an obstacle is encountered on the road.

Although all these devices can reduce the amount of air flowing under the vehicle, none of them solves all the above-mentioned constraints.

### SUMMARY OF THE INVENTION

The aerodynamic deflector according to the invention is characterised in that it comprises a deformable skin of which an upper strip is rigidly connected to the lower portion of a front bumper, and of which a lower strip is connected to a front edge of a rigid arch that can be moved by a manoeuvring device between a low position in which the deformable skin is deployed so as to divert the flow of air that presents under the vehicle when the vehicle advances, and a high position in which the deformable skin is folded away in a recess arranged behind the bumper.

Due to the flexibility of the skin and its ability to deform, the skin can now be folded away or deployed while avoiding the constraints related to the pronounced curve of the lower profile of the bumper, and deformable skin can be placed in front of the vehicle wheels across the entire width of the bumper. The deformable skin therefore comes in continuity of shape with the general shape of the front bumper and follows the lower curve of the bumper from one end of the bumper to the other.

As we will see below, this advantage also offers the possibility of proposing a compact and lightweight manoeuvring device allowing the deformable skin to fold away on itself and undergo controlled deformations, to enter the recess provided for this purpose behind the bumper, or to deploy completely to deflect the flow of air passing under the vehicle.

The device according to the invention may also comprise, taken alone or in combination, the following characteristics:
In the low position, the deformable skin extends laterally in front of each of the front wheels of the vehicle.
In the low position, the lower strip of the deformable skin is arranged at a substantially constant height from the ground.
The deformable skin is in continuity of shape with the front bumper below which it extends when the rigid arch is arranged in the low position.
The front edge of the rigid arch to which the lower strip of the deformable skin is attached is curved.
The rigid arch is made of a plastic or composite material.
The manoeuvring device comprises:
   one or more front connecting rods, each of the front connecting rods having a first end connected to the vehicle chassis by a first hinge of axis dd′, and a second end connected to the rigid arch by a second hinge of axis cc′,
   one or more rear connecting rods, each of the rear connecting rods having a first end connected to the vehicle chassis by a first hinge of axis aa′, and a second end connected to the rigid arch by a second hinge of axis bb′,
      and the axes aa′, bb′, cc′ and dd′ are parallel to each other and to the transverse direction OY of the vehicle and arranged so that the projections of said axes on a plane perpendicular to said axes define the four vertices of a deformable right parallelogram; the axis aa′ is offset from the axis dd′, in the longitudinal direction towards the rear of the vehicle, by a non-zero distance d.
The manoeuvring device is arranged so that the rigid arch moves towards the rear of the vehicle when moving from the low position to the high position.
One of the two axes by which the first ends of the connecting rods are connected to the chassis is an actuation shaft mounted on two bearings attached to the chassis, and driven in rotation by an actuator.
The first ends of the rear connecting rods are attached to the actuating shaft of axis aa′.
The actuator comprises a torque limiter whose threshold is adjusted so that, when the vehicle is moving and the rigid arch hits an obstacle, the actuator is disengaged and the rigid arch moves from the low position to the high position under the effect of the momentum acquired during the impact by said rigid arch.
A return connecting rod parallel to a plane passing through axes aa′ and dd′ is connected by one of its ends to a front connecting rod, or to a rear connecting rod, by a hinge of axis ff′ parallel to the axis aa′, and by its other end to a secondary driving connecting rod by a hinge of axis ee′ parallel to the axis aa′, said secondary driving connecting rod being parallel to the front connecting rod, or to the rear connecting rod, and comprising another end attached to the actuation shaft.
The manoeuvring device comprises two rear connecting rods each arranged near the two lateral ends of said rigid arch.
The manoeuvring device comprises a single front connecting rod arranged substantially at the centre of said rigid arch.

### BRIEF DESCRIPTION OF THE DRAWINGS

The invention will be better understood on reading the accompanying figures, which are given solely by way of example and not limiting in any way, in which:

FIG. 1 is a diagrammatic perspective view of the front of a vehicle.

FIG. 2 is a diagrammatic perspective view of the front of a vehicle in which the aerodynamic deflector is deployed.

FIG. 3 is a diagrammatic perspective view of the front of a vehicle in which the manoeuvring device is visible.

FIG. 4 is a diagrammatic perspective view of the manoeuvring device.

FIG. 5 is a diagrammatic side view of the manoeuvring device in the high position.

FIG. 6 is a diagrammatic view from underneath of the manoeuvring device in the high position.

FIG. 7 is a diagrammatic perspective view of the actuation shaft and of the actuator of the manoeuvring device.

### DETAILED DESCRIPTION OF THE INVENTION

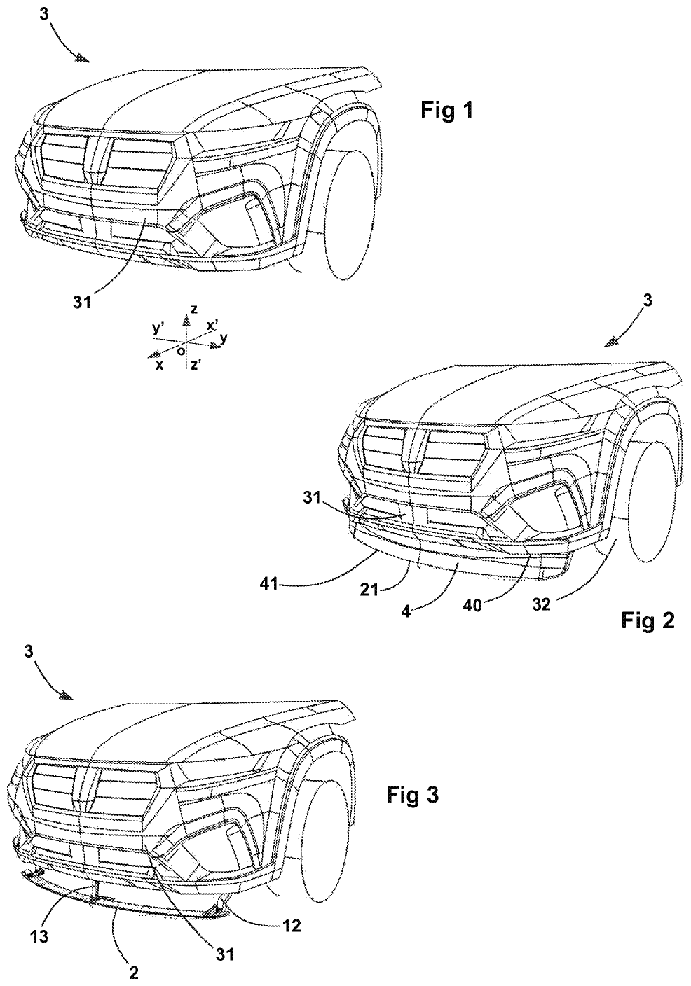

FIG. 1 is a partial front view of the front of a vehicle 3 comprising a front bumper 31. This bumper is rigidly connected to the vehicle chassis by fasteners (not shown). The aerodynamic deflector is in the high position and remains invisible from outside the vehicle.

In the remainder of the document, longitudinal direction means the direction X′OX going from the rear to the front of the vehicle, transverse direction means the direction Y′OY parallel to the wheel axes, and vertical direction means the direction Z′OZ perpendicular to the plane on which the vehicle moves.

FIG. 2 shows the same front of a vehicle 3 in which the deformable skin 4 is deployed in the low position. The deformable skin 4 extends over the entire front of the vehicle and reduces the flow of air arriving on the front part and passing under the bumper when the vehicle is travelling at high speed. Note that the deformable skin 4 also moves partially in front of the front wheels.

The deformable skin 4 is connected by its upper strip 40 to the lower edge of the front bumper 31, and by its lower strip 41 to a rigid arch 2, shown on FIG. 3 in which the deformable skin 4 has been removed. The deformable skin 4 is in continuity of shape with the front bumper 31 and follows the curve of its lower edge. For the same reasons, the front edge of the rigid arch 2 also has a curve similar to that of the lower part of the bumper.

In this low position, the lower strip 41 of the deformable skin and the rigid arch 2 are positioned at a relatively constant height from the ground.

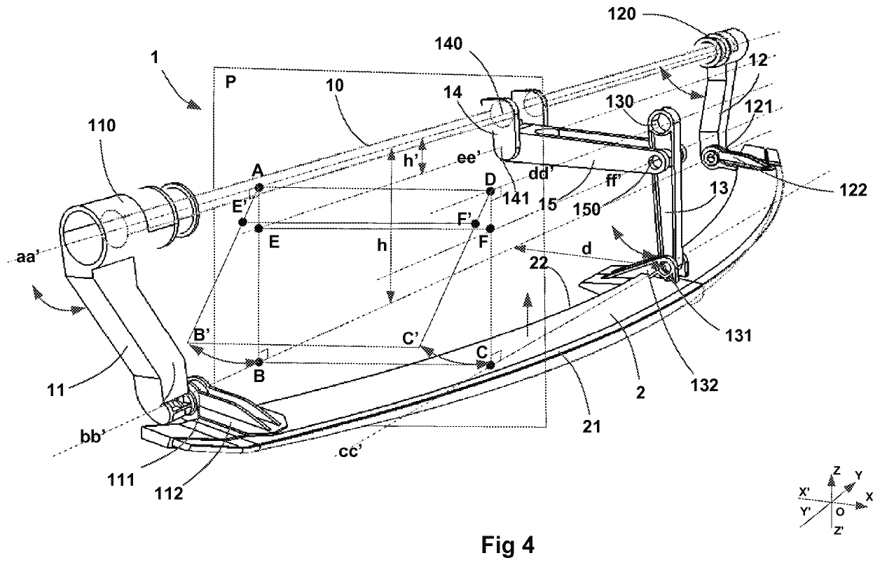

The manoeuvring device 1 used to deploy or retract the deformable skin on which this description is based is shown in detail on FIG. 4. On this figure, the rigid arch 2 is arranged in the low position corresponding to the case in which the deformable skin 4 (not shown) is deployed.

The rigid arch 2 has a front edge 21 to which the lower strip 41 of the deformable skin 4 is attached.

For purposes of impact resistance, vibratory rigidity and lightness, the rigid arch 2 may advantageously be made of a composite or thermoplastic material.

The rigid arch 2 is connected to the vehicle chassis by two rear connecting rods 11 and 12 and by one front connecting rod 13.

The front connecting rod 13 comprises a first end connected to the vehicle chassis by a first hinge 130 of axis dd′, and a second end connected to the rigid arch by a second hinge 131 of axis cc′.

The rear connecting rods 11 and 12 comprise a first end connected to the vehicle chassis by a first hinge, respectively 110 and 120, of axis aa′, and a second end connected to the rigid arch 2 by a second hinge, respectively 111 and 121, of axis bb′. The second hinges of the rear and front connecting rods are attached to the rigid arch 2 by base plates, respectively 112, 122 and 132.

The axes aa′, bb′, cc′ and dd′ are parallel to each other and to the transverse direction OY of the vehicle and arranged so that the projections A, B, C, D, of the axes aa′, bb′, cc′ and dd′ on a plane P perpendicular to said axes define the four vertices of a deformable right parallelogram. The axis aa′ is offset from the axis dd′, in the longitudinal direction towards the rear of the vehicle, by a non-zero constant distance d equal to the constant distance between the axes bb′ and cc′. The constant distance between the axes aa′ and bb′ or between the axes cc′ and dd′ is equal to h.

The number of front connecting rods and rear connecting rods is not limited to the number given in this description. Thus, it is quite possible to consider multiple combinations in which there are a single rear connecting rod and a single front connecting rod, or a single rear connecting rod and two front connecting rods or, for greater rigidity, two rear connecting rods and two front connecting rods. However, due to the pronounced curve of the rigid arch 2, the front connecting rods are preferably positioned near the centre of the rigid arch, defined here as being the line of intersection of the vehicle longitudinal plane of symmetry OXZ with the rigid arch, and arranged at equal distances from the two lateral ends of the rigid arch.

In all these configurations, the first ends of the rear connecting rods are connected to the vehicle chassis by first hinges of axis aa′, and the second ends of the rear connecting rods are connected to the rigid arch 2 by second hinges of axis bb′. Similarly, the first ends of the front connecting rods are connected to the vehicle chassis by first hinges of axis dd′, and the second ends of the front connecting rods are connected to the rigid arch 2 by second hinges of axis cc′.

In the device on which this description is based, the first ends of the rear connecting rods 11 and 12 are attached to an actuation shaft 10 of axis aa′ connected to the chassis by bearings 100 and 101, shown on FIGS. 6 and 7, and which act as first hinge. The actuation shaft 10 is driven in rotation by an actuator 5 arranged at one of the lateral ends of said actuation shaft 10.

This arrangement, in which the actuation shaft is placed as far back as possible, allows better deformation of the front part of the vehicle in case of head-on impact. In addition, the actuator and the rear connecting rods, which are expensive to replace, are better protected by being located as far away as possible from the impact areas on the bumper.

The first hinge 130 of the front connecting rod can rotate freely about the axis dd′, and the second hinges, respectively 111, 121, 131 connecting the rear connecting rods and the front connecting rod to the rigid arch can rotate freely about their respective axes, bb′ and cc′.

By rotating a quarter turn about the axis aa′, the actuation shaft 10 pivots the rear connecting rods 11 and 12 and moves the rigid arch from the low position in which the connecting rods are substantially oriented along the vertical axis to the high position in which the connecting rods are substantially oriented along the longitudinal axis. During this movement, the rigid arch moves in translation from the front to the rear of the vehicle.

The front connecting rod is moved by the displacement of the rear connecting rods and the rigid arch. The parallelogram formed by the front and rear connecting rods deforms about the fixed axes aa′ and dd′. Points B and C move in the plane P to B′ and C′.

We see that during this movement, the plane formed by the axis bb′ and cc′, which can be assimilated to the plane of the rigid arch 2, remains substantially parallel to the plane formed by the ground on which the vehicle travels.

In the device on which the description of the invention is based, the actuation shaft is a rotating shaft of axis aa′ driving in rotation the rear connecting rods 11 and 12. We see that it is also possible to position the actuation shaft on the axis dd′ to drive the front connecting rod. Or to rotate one of the connecting rods using a secondary shaft moving along a substantially linear path.

In all the above-mentioned arrangements, care must be taken to ensure that the actuator, or more generally the means for driving in rotation the front and rear connecting rods, can be disengaged under the effect of an abnormal mechanical stress. When the vehicle is moving and the rigid arch is placed in the low position, the vehicle ground clearance is lowered, and the rigid arch could in fact hit an obstacle placed on the road. The integrity of the rigid arch, the deformable skin, and more generally of the connecting rods forming the manoeuvring device, must therefore be preserved.

Thus, the actuator 5 comprises a torque limiter whose threshold is adjusted so that, when the vehicle is moving and the rigid arch hits an obstacle, the actuator is disengaged and the rigid arch moves from the low position to the high position by moving from the front to the rear, under the effect of the momentum acquired during the impact between said rigid arch 2 and said obstacle. The lighter the rigid arch the smaller the momentum and the lower the damage due to the impact between the rigid arch and the obstacle.

Advantageously, the manoeuvring device may comprise additional drive elements for transmitting the driving force generated by the actuation axis 10 to the front connecting rod 13 so as to avoid transmitting excessive forces in the rods.

The manoeuvring device 1 comprises a return connecting rod 15 parallel to a plane passing through the axes aa′ and dd′, which is connected by one of its ends to the front connecting rod 13 by a hinge 150 of axis ff′ parallel to the axis aa′, and by its other end to a secondary driving connecting rod 14 by a hinge 141 of axis ee′ parallel to the axis aa′. The secondary driving connecting rod 14 is parallel to the front connecting rod 13, and comprises another end 140 attached to the actuation shaft 10.

The projection of axes aa′, ee′, ff′ and dd′ on the plane P forms the four vertices A, E, F, D of a deformable parallelogram. The constant distance between the axes aa′ and ee′ or between the axes dd′ and ff′ is equal to h′, and the constant distance between the axes ee′ and ff′, which is the same as that between the axes aa′ and dd′, is equal to d. When the manoeuvring device is moving, the points E and F move to E′ and F′.

The secondary driving connecting rod 14 and the return connecting rod 15 thus transmit some of the torque from the actuation shaft 10 to the front connecting rod 13, so as to reduce the transmission forces in the hinges located between the rear connecting rods 111 and 121 and the rigid arch 2, and avoid the irreversible deformation of the parallelogram formed by the axes aa′, bb′, cc′ and dd′.

Obviously, when the actuation shaft is arranged on the axis dd′ to which the first hinges of the front connecting rods are attached, the secondary driving connecting rod is then connected to the front actuation shaft and the return connecting rod to a rear connecting rod.

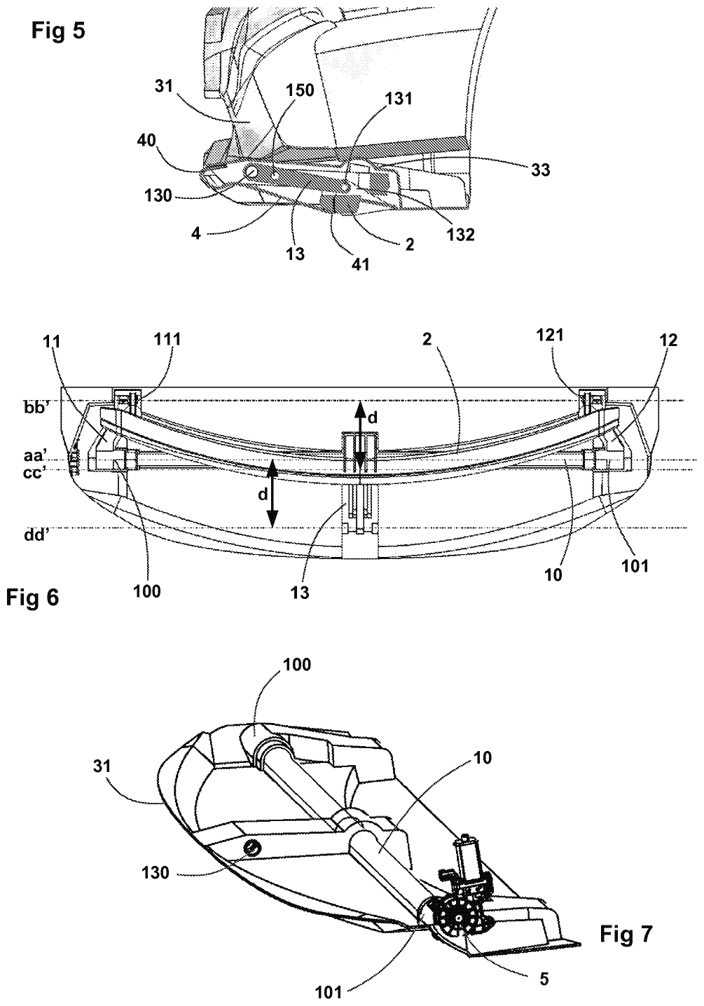

FIG. 5 is a profile view of the aerodynamic deflector in the high folded position. The deformable skin 4 is attached by its upper strip 40 to the bumper 31 and by its lower strip 41 to the rigid arch 2. The front connecting rod 13 is folded away in a recess 33 located under the front bumper 31.

FIG. 6 is a view from underneath of the manoeuvring device when the rigid arch 2 is placed in the high position corresponding to FIG. 5.

The rear connecting rods 11 and 12 and the front connecting rod are arranged in the high position.

FIG. 7 shows the actuation shaft 10 and the actuator 5. We see that the actuator is arranged at one of the lateral ends of the actuation shaft so as to reduce the risks of damage in case of head-on impact.

Configured in this way, the aerodynamic deflector can meet most of the design constraints mentioned in the introduction to this description.

In particular, it offers sufficient resistance to the aerodynamic force exerted on the skin in the low deployed position, a possibility of folding away quickly when an unplanned obstacle appears on the road, reduced size in the high folded position, and ease of repair in case of head-on impact. Lastly, the deformable skin may have an outer profile in perfect continuity of shape and style with the vehicle bumper so that it can be deployed over a substantially constant height across the entire width of the vehicle, and in particular in front of the wheels.

### PARTS LIST

1 Manoeuvring device.
10 Actuation shaft.
100, 101 Bearings of the actuation shaft 10 mounted on the vehicle chassis.
11 Rear connecting rod.
110 First hinge of the connecting rod 11; link of the rear connecting rod 11 on the actuation shaft 10.
111 Second hinge between the rear connecting rod 11 and the rigid arch 2.
112 Attachment base plate of the second hinge of the rear connecting rod 12 on the rigid arch 2.
12 Rear connecting rod.
120 First hinge of the connecting rod 12; link of the rear connecting rod 12 on the actuation shaft 10.
121 Second hinge between the rear connecting rod 12 and the rigid arch 2.
122 Attachment base plate of the second hinge of the connecting rod 12 on the rigid arch 2.
13 Front connecting rod.
130 First hinge between the front connecting rod and the chassis.
131 Second hinge between the front connecting rod 13 and the rigid arch 2.
132 Attachment base plate of the second hinge of the connecting rod 13 on the rigid arch 2.
14 Secondary driving connecting rod.
140 Link of the secondary driving connecting rod 14 on the actuation shaft 10.
141 Hinge between the secondary driving connecting rod 14 and the return connecting rod 15.
15 Return connecting rod.
150 Hinge between the return connecting rod 15 and the front connecting rod 13.
aa′ Axis of the actuation shaft.
bb′ Axis of the hinges 111 and 121.
cc′ Axis of the hinge 131.
dd′ Axis of the hinge 130.
ee′ Axis of the hinge 141.
ff′ Axis of the hinge 150.
h Distance between the axes aa′ and bb′; equal to the distance between the axes cc′ and dd′.
h′ Distance between the axes aa′ and ee′; equal to the distance between the axes dd′ and ff′.
d Distance between the axes bb′ and cc′; equal to the distance between the axes aa′ and dd′.
2 Rigid arch.
21 Front edge of the rigid arch to which the lower strip 41 of the deformable skin 4 is attached.
22 Rear edge of the rigid arch.
3 Vehicle.
31 Bumper.
32 Front wheels.
33 Recess located under the bumper.
4 Deformable skin.
40 Upper strip of the deformable skin.
41 Lower strip of the deformable skin.
5 Actuator.

1. An aerodynamic deflector arranged at the front of a motor vehicle comprising a deformable skin of which an upper strip is rigidly connected to the lower portion of a front bumper, and of which a lower strip is connected to a front edge of a rigid arch that can be moved by a maneuvering device between a low position in which the deformable skin is deployed so as to divert the flow of air that presents under the vehicle when the vehicle advances, and a high position in which the deformable skin is folded away in a recess arranged behind the bumper.

2. The aerodynamic deflector according to claim 1, wherein, when the rigid arch is arranged in the low position, the deformable skin extends laterally in front of each of the front wheels of the vehicle.

3. The aerodynamic deflector according to claim 1, wherein, when the rigid arch is arranged in the low position, the lower strip of the deformable skin is arranged at a substantially constant height from the ground.

4. The aerodynamic deflector according to claim 1, wherein the deformable skin is in continuity of shape with the front bumper below which it extends when the rigid arch is arranged in the low position.

5. The aerodynamic deflector according to claim 1, wherein the front edge of the rigid arch to which the lower strip of the deformable skin is attached is curved.

6. The aerodynamic deflector according to claim 1, wherein the rigid arch is made of a plastic or composite material.

7. The aerodynamic deflector according to claim 1, wherein the maneuvering device comprises:
one or more front connecting rods, each of the front connecting rods having a first end connected to the vehicle chassis by a first hinge of axis dd′, and a second end connected to the rigid arch by a second hinge of axis cc′,
one or more rear connecting rods, each of the rear connecting rods having a first end connected to the vehicle chassis by a first hinge of axis aa′, and a second end connected to the rigid arch by a second hinge of axis bb′,
and wherein:
the axes aa′, bb′, cc′ and dd′ are parallel to each other and to the transverse direction (OY) of the vehicle and arranged so that the projections of said axes (aa′, bb′, cc′, dd′) on a plane (P) perpendicular to said axes define the four vertices (A, B, C, D) of a deformable right parallelogram.
the axis aa′ is offset from the axis dd′, in the longitudinal direction towards the rear of the vehicle, by a non-zero distance d.

8. The aerodynamic deflector according to claim 7, wherein the maneuvering device is arranged so that the rigid arch moves towards the rear of the vehicle when moving from the low position to the high position.

9. The aerodynamic deflector according to claim 7, wherein one of the two axes (aa′, dd′) by which the first ends of the connecting rods are connected to the chassis is an actuation shaft mounted on two bearings attached to the chassis, and driven in rotation by an actuator.

10. The aerodynamic deflector according to claim 9, wherein the first ends of the rear connecting rods are attached to an actuation shaft of axis aa′.

11. The aerodynamic deflector according to claim 10, wherein the actuator comprises a torque limiter whose threshold is adjusted so that, when the vehicle is moving and the rigid arch hits an obstacle, the actuator is disengaged and the rigid arch moves from the low position to the high position under the effect of the momentum acquired during the impact by said rigid arch.

12. The aerodynamic deflector according claim 7, wherein a return connecting rod parallel to a plane passing through axes aa′ and dd′ is connected by one of its ends to a front connecting rod, or to a rear connecting rod, by a hinge of axis ff′ parallel to the axis aa′, and by its other end to a secondary driving connecting rod by a hinge of axis ee′ parallel to the axis aa′, said secondary driving connecting rod being parallel to the front connecting rod, or to the rear connecting rod, and comprising another end attached to an actuation shaft.

13. The aerodynamic deflector according to claim 7, wherein the maneuvering device comprises two rear connecting rods each arranged near the two lateral ends of said rigid arch.

14. The aerodynamic deflector according to claim 7, wherein the maneuvering device comprises a single front connecting rod arranged substantially at the centre of said rigid arch.
